(19) United States
(12) Patent Application Publication
(10) Pub. No.: US 2024/0426693 A1
(43) Pub. Date: Dec. 26, 2024

(54) HIGH VOLTAGE LEAK DETECTION

(71) Applicant: ATS CORPORATION, Cambridge (CA)

(72) Inventors: Stanley Wellington Kleinikkink, Cambridge (CA); Roger Hogan, Cambridge (CA); Amir Ashrafizadeh, Cambridge (CA); Calin-Adrian Alexander, Cambridge (CA)

(21) Appl. No.: 18/755,390

(22) Filed: Jun. 26, 2024

Related U.S. Application Data
(60) Provisional application No. 63/523,240, filed on Jun. 26, 2023.

(51) Int. Cl. G01M 3/18

(52) U.S. Cl. CPC G01M 3/186

(57) ABSTRACT

High voltage leak detection can be used to detect leaks in containers and is particularly useful in pharmaceutical applications in which small leaks in sterile containers such as viles, syringes, ampules etc. must be detected reliably. The high voltage leak detection relies upon the fluid within the container being at least partially conducting. The container, and so the fluid within it, are spun at a high RPM to force the liquid into any cracks or holes which can then be detected by monitoring the electrical characteristics. Advantageously, the leak detection may be performed with the container in a vertical orientation by spinning the container at an RPM sufficient to spin the liquid up the sides of the container.

### RELATED APPLICATIONS

The current application claims priority to U.S. Provisional Application No. 63/523,240 filed Jun. 26, 2023 entitled, “High Voltage Leak Detection,” the entire contents of which are incorporated herein by reference in their entirety.

### TECHNICAL FIELD

The current disclosure relates to detecting leaks in a container containing a liquid, and in particular to leak detection using high voltage testing.

### BACKGROUND

The storage and transport of liquids is important in many industries including in the pharmaceutical industry. Containers such as vials, bottles, tubes, and syringes may be used for storing and transporting pharmaceuticals. These containers, which often need to be sterilized, can be made of glass. While glass is well suited for sterilization and holding pharmaceuticals, the containers can be susceptible to minor cracks or pin holes or other defects that can cause leaks, rendering the container unsuitable for purposes requiring a sealed container.

A high voltage leak detection technique can be used to test the containers filled with a liquid that conducts electricity for leaks. The high voltage leak detection process spins the container in a horizontal orientation. The container is spun in a horizontal orientation in order to force the liquid around the entire container. The liquid is forced into any cracks or defects as a result of the spinning of the container. Since the glass container is an insulator, any cracks or defects that are filled with the conductive liquid can be detected by applying a high voltage to the container. Spinning the container in the horizontal orientation ensures that the liquid reaches all parts of the container, including those portions that would be above the liquid level with the container in the vertical orientation.

An additional, alternative and or improved process for leak detection is desirable.

### BRIEF DESCRIPTION OF THE DRAWINGS

Further features and advantages of the present disclosure will become apparent from the following detailed description, taken in combination with the appended drawings, in which:

FIG. 1 depicts a process for leak detection with a container in a vertical orientation;

FIG. 2 depicts a further process for leak detection with a container in a vertical orientation;

FIG. 3 depicts a method for leak detection with a container in a vertical orientation; and

FIG. 4 depicts a system incorporating leak detection with a container in a vertical orientation.

### DETAILED DESCRIPTION

In accordance with the present disclosure there is provided a method for detecting a leak in a container, the method comprising: receiving a container in a vertical orientation, the container made from a non-conductive material and at least partially filed with a conductive liquid; spinning the container in the vertical orientation up to a first RPM level, thereby causing the conductive liquid to rise up sides of the container; and testing for a leak in the spinning container while in the vertical orientation using a high-voltage leak detection process.

In a further embodiment of the method, the method further comprises: after spinning the container up to the first RPM level and before testing for the leak, reducing the RPM to a second RPM level lower than the first RPM level.

In a further embodiment of the method, the first RPM level is above a testing RPM range of the high-voltage leak detection process and the second RPM level is within the testing RPM range of the high-voltage leak detection process.

In a further embodiment of the method, the first RPM is approximately 3000 RPMs and the second RPM level is approximately 1500 RPMs.

In a further embodiment of the method, the first RPM level is within a testing RPM range of the high-voltage leak detection process. The method of any one of claims 1 to 4, wherein the high-voltage leak detection process provides an indication of whether the container passed or failed the testing.

In a further embodiment of the method, the method further comprises performing at least one additional testing procedure while the container is still held in the vertical orientation.

In a further embodiment of the method, the at least one additional testing procedure is performed during the high-voltage leak detection process.

In a further embodiment of the method, the at least one additional testing procedure is performed after the high-voltage leak detection process.

In a further embodiment of the method, the container comprises one of: a sealed glass vial; a sealed glass ampule; a sealed glass tube; and a sealed glass syringe.

In accordance with the present disclosure there is further provided a system for detecting a leak in a container, the system comprising: a first actuator for securing a container in a vertical orientation, the container made from a non-conductive material and at least partially filed with a conductive liquid; a second actuator connected to the first actuator for spinning the first actuator with secured container; a high voltage leak detection tester for detecting a possible leak in the container using a high voltage leak detection process; and a controller configured to perform a method according to any one of the methods described above.

In a further embodiment of the system, the system further comprises at least one additional testing device.

In a further embodiment of the system, the at least one additional testing device comprises one or more of: a static image testing device; and a spin image testing device.

In a further embodiment of the system, the static image testing device is arranged before the high voltage leak detection tester and the spin image testing device is arranged after the high voltage leak detection tester.

In accordance with the present disclosure there is further provided a non-transitory computer readable medium having stored thereon instructions which when executed by a processor perform a method comprising receiving a container in a vertical orientation, the container made from a non-conductive material and at least partially filed with a conductive liquid; spinning the container in the vertical orientation up to a first RPM level, thereby causing the conductive liquid to rise up sides of the container; and testing for a leak in the spinning container while in the vertical orientation using a high-voltage leak detection process.

In a further embodiment of the non-transitory computer readable medium, the method performed by executing the stored instructions further comprises after spinning the container up to the first RPM level and before testing for the leak, reducing the RPM to a second RPM level lower than the first RPM level.

In a further embodiment of the non-transitory computer readable medium, the first RPM level is above a testing RPM range of the high-voltage leak detection process and the second RPM level is within the testing RPM range of the high-voltage leak detection process.

In a further embodiment of the non-transitory computer readable medium, the first RPM is approximately 3000 RPMs and the second RPM level is approximately 1500 RPMs.

In a further embodiment of the non-transitory computer readable medium, the first RPM level is within a testing RPM range of the high-voltage leak detection process.

Pharmaceuticals are generally stored in sealed and sterilized containers in order to maintain the pharmaceutical in a safe and useable condition. If the container is not sterilized, or not fully sealed, the pharmaceutical may be contaminated and no longer safe to use. Glass containers can be readily sterilized, however, small or microscopic cracks and/or holes can result in the container not being fully sealed.

During the filling and/or packaging of the containers with the pharmaceutical, it is highly desirable to check the container for any cracks or holes in the container that could result in a leak. One technique for checking for leaks that can be used with a non-conductive container that is at least partially filled with a conductive liquid is to use high voltage leak detection. In high voltage leak detection, the container is spun at a relatively high RPM, which will force the conductive liquid into any cracks or holes. The electrical characteristics of a container with no cracks or holes will differ from those with cracks/holes filled with the conductive liquid when a high voltage is applied. The difference in the electrical characteristics can be detected and used to identify containers with cracks and/or holes, which can subsequently rejected from packaging.

The high voltage leak detection relies upon the conductive liquid in the container being present in the cracks/holes. As such, the containers have been rotated in a horizontal position to ensure that the liquid can be forced into any cracks/holes even if the cracks/holes are above a fill level of the container in the vertical orientation. While the leak detection with the container in a horizontal position functions well, it can be a relatively slow process during packaging as it can require repositioning how the container is held. In an automated, or semi-automated, packaging process such repositioning operations can slow the process as well as increase the complexity of the packaging system.

As described further below, a high voltage leak detection process can be performed with the container oriented in the vertical orientation while still ensuring that cracks/holes above a liquid fill level can still be detected. The container is spun to an RPM that is sufficiently high to cause the liquid to be forced up the sides of the container up to the top of the container. With the liquid forced up the sides, and into and cracks/holes, leaks can be detected using a high voltage leak detection technique. The vertical high voltage leak detection described herein can provide a higher throughput packaging system since the container may not need to be repositioned for different operations. That is, other operations, such as detecting foreign particles within the container, can be performed with the container held in the same orientation.

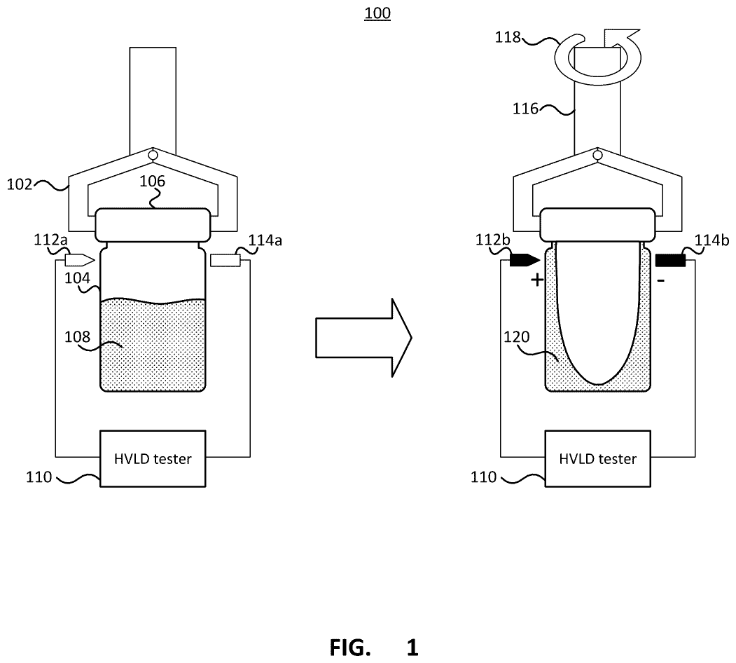

FIG. 1 depicts a process for leak detection with a container in a vertical orientation. The process 100 depicts an actuator 102 that can hold a container in a vertical orientation. The actuator 102 is depicted schematically as a gripper style actuator that can grip a cap of the container; however, other types of actuators can be used to hold the container. Additionally, although the actuator 102 is depicted as contacting the container at the top or cap of the container, different actuators may contact the container at various different locations. The container 104 is depicted as a glass vial sealed with a cap 106. Different containers may be used such as ampules, tubes, syringes, etc. Regardless of the particular shape of the container it is at least partially filled with a liquid 108. In order for the high voltage leak detection process to function properly, the liquid is electrically conductive and the container is not electrically conductive, or at least significantly less conductive compared to the liquid. A high voltage leak detection (HVLD) tester 110 comprises the electronics necessary to generate the high voltage for testing as well as for monitoring the electrical characteristics of the container during the test. The voltage can be applied to the container by a pair of electrodes 112a, 114a. The electrodes may be stationary, or one or more of the electrodes 112a, 114a may move along the container, for example by raising/lowering the container relative to the electrodes, in order to test different portions of the container.

Once the container is held by the actuator 102 in the vertical orientation, a second actuator 116 spins the container 104 up to a sufficiently high RPM (revolution per minute) depicted by arrow 118 that will cause the liquid 120 to rise up the sides of the container. With the liquid forced all the way up the container walls by the high RPM, it will enter any cracks or holes present in the container. With the liquid forced up the walls and into any cracks/holes present, the HVLD tester 110 can apply the high voltage to the electrodes, depicted by solid black electrodes 112b, 114b, and measure the resulting electrical characteristics in order to test for leaks. As a result of the measurements, the HVLD tester can provide an indication of whether or not any leaks were detected in the container.

Although the specific details of the HVLD tester 110 can vary, the basis of the process is a difference in the equivalent electrical schematic of a good container compared to a bad container. With the electrodes applying a voltage across the good container, the equivalent circuit may be represented as a voltage applied across two capacitors representing the container walls with a resistor, representing the conductive liquid, connected between the two capacitors. In a bad container, the equivalent circuit has at least one of the capacitors eliminated since the conductive liquid will flow through the container wall through the crack/hole. The difference in the electrical characteristics between the two different equivalent circuits can be detected and the container passed or failed as a result.

Although not depicted in FIG. 1, the HVLD tester provides an indication of whether the container passed the leak detection test, that is, no cracks or holes were detected, or failed the test. The indication may be provided in various ways, including an audio signal, a visual signal, and/or an electrical signal. The indication of the test result may be provided to one or more operators and/or different components of a filling and packaging system. For example, the HVLD tester may provide data to a controller that can move the container either to a rejected container location or line or to an accepted location or line.

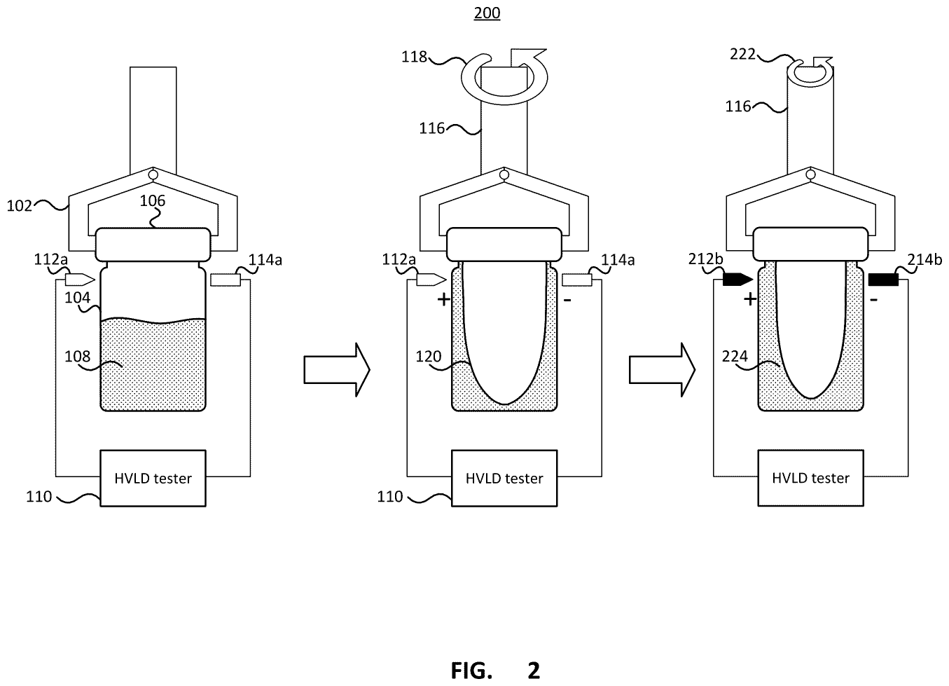

FIG. 2 depicts a process for leak detection with a container in a vertical orientation. The process 200 is similar to the process 100 described above. However, in the process of FIG. 2, it is assumed that the HVLD tester 210 has an operating range specifying a testing RPM of the container that it can operate at and that the testing RPM of the tester is below the RPM, depicted by arrow 118, that causes the liquid to rise up the sides of the container 120. In such a scenario, the container is spun to the first RPM 118 that is above the testing RPM, in order to force the liquid 120 up walls and then the RPM is reduced, depicted by arrow 222 to be within the testing RPM range of the HVLD tester 110. Although the RPM is reduced, the liquid 224 may still remain raised up the container side walls, at least for short period of time. Once the RPM is within the testing range, the HVLD tester 110 can apply the high voltage, depicted by solid black electrodes 112b, 114b, and determine if the container has leaks or not.

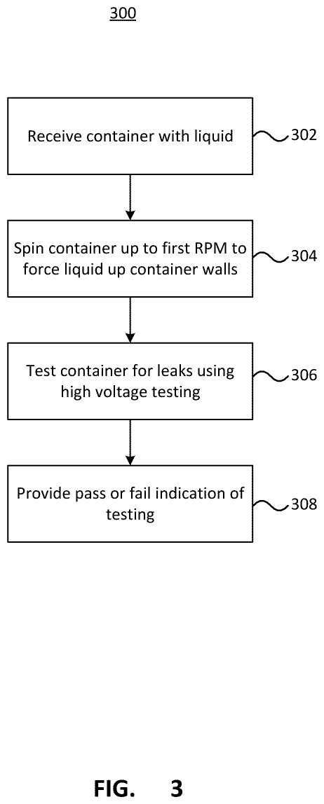

FIG. 3 depicts a method for leak detection with a container in a vertical orientation. The method 300 begins with receiving a container that is at least partially filled with a liquid (302). The container is held in a vertical orientation. The liquid in the container is a conductive liquid and the container is non-conductive, or at least substantially less conductive compared to the liquid. The container is filled with enough liquid that when the container is spun at a high RPM there is enough liquid to cover the side walls of the container to the top of the container. With the container in the vertical orientation, it is spun up to a first RPM (304) that is sufficient to force the liquid within the container up the side walls of the container. As the liquid is spun up the container walls, it is forced into any defects such as cracks and/or holes in the container. The container is tested for leaks using a high voltage leak detection process (306) by applying a high voltage across the container and measuring the resulting electrical characteristics to determine if there is a leak or not in the container. The test is performed while the conductive liquid remains raised up along the side walls of the container. An indication of whether or not the container passed or failed the leak test can be provided (308) and subsequent actions taken based on the indication. For example, a container that failed the leak detection test can be moved to a rejection area or rejection line. Containers that passed the leak detection test can continue passing through a packaging line or process.

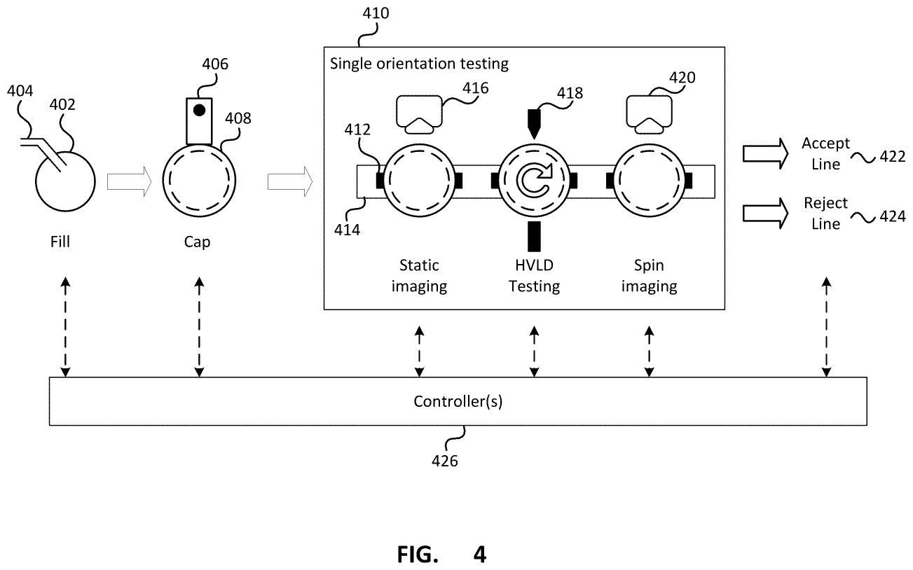

FIG. 4 depicts a system incorporating leak detection with a container in a vertical orientation. The system 400 may incorporate the vertical high voltage leak detection as well as other processes in the filling and packaging process. A container 402 may be processed in an autonomous, or semi-autonomous filling and packaging process in which the container, which may be previously sterilized, or sterilized in an operation or station not depicted in FIG. 4, is filled 404. The container may be filled or partially filled with a liquid and then moved to a capping operation 406 in which a cap 408 can be fixed to the container 402. Although depicted as applying a cap to the container, the container can be sealed in other ways. The sealed container 406 may be held in a vertical orientation 410 and passed through several testing and/or verification processed. For example, the container may be held by an actuator 412 that can hold the container in the vertical orientation. The actuator 412, and the container, can pass through one or more testing/verification operations for example on a conveyer or similar system 414, without requiring the container to repositioned or held by a different actuator. Since the actuator holding the container does not need to change between the different operations, it may result in a higher throughput system. As depicted, the single orientation testing 410 may include a static imaging system 416, which may be used to verify certain aspects of the container, such as identifying and/or verifying a fill level of the container, capturing identifying information on a label of the container, or possibly identifying/verifying visual features of the container. The static imaging system 416 may capture images while the container and/or the liquid is static, or substantially static. The container may then be spun up to a high RPM and pass through a high voltage leak detection 418 such as that described above. The spinning of the container may be stopped and the container passed to a spin imaging system 420 that may detect the presence of particles within the liquid while the liquid remains in motion. Such a spin imaging process is described in U.S. Provisional Patent 63/405,125, filed Sep. 9, 2022 and titled “PARTICLE INSPECTION FOR LIQUID CONTAINERS,” the entire contents of which are incorporated herein by reference in their entirety. Based on the results of one or more of the testing and/or verification processes, the container may be passed to an accept line 422 of the packaging process for further processing or to a reject line 424.

The controller 426 depicted in FIG. 4 may comprise one or more controllers, processors, application specific integrated circuits (ASICs), field programmable gate arrays (FPGAs), and control operation of the individual components of the system 400 as well as the overall operation of the system 400. The controller 426, or controllers, may be in communication with one or more other controllers in order to operate the system 400 as desired.

It will be appreciated by one of ordinary skill in the art that the system and components shown in FIGS. 1-4 may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. A method for detecting a leak in a container, the method comprising:
receiving a container in a vertical orientation, the container made from a non-conductive material and at least partially filed with a conductive liquid;
spinning the container in the vertical orientation up to a first RPM level, thereby causing the conductive liquid to rise up sides of the container; and
testing for a leak in the spinning container while in the vertical orientation using a high-voltage leak detection process.

2. The method of claim 1, further comprising:
after spinning the container up to the first RPM level and before testing for the leak, reducing the RPM to a second RPM level lower than the first RPM level.

3. The method of claim 2, wherein the first RPM level is above a testing RPM range of the high-voltage leak detection process and the second RPM level is within the testing RPM range of the high-voltage leak detection process.

4. The method of claim 2, wherein the first RPM level is approximately 3000 RPMs and the second RPM level is approximately 1500 RPMs.

5. The method of claim 1, wherein the first RPM level is within a testing RPM range of the high-voltage leak detection process.

6. The method of claim 1, wherein the high-voltage leak detection process provides an indication of whether the container passed or failed the testing.

7. The method of claim 1, further comprising performing at least one additional testing procedure while the container is still held in the vertical orientation.

8. The method of claim 7, wherein the at least one additional testing procedure is performed during the high-voltage leak detection process.

9. The method of claim 7, wherein the at least one additional testing procedure is performed after the high-voltage leak detection process.

10. The method of claim 1, wherein the container comprises one of:
a sealed glass vial;
a sealed glass ampule;
a sealed glass tube; and
a sealed glass syringe.

11. A system for detecting a leak in a container, the system comprising:
a first actuator for securing a container in a vertical orientation, the container made from a non-conductive material and at least partially filed with a conductive liquid;
a second actuator connected to the first actuator for spinning the first actuator with secured container;
a high voltage leak detection tester for detecting a possible leak in the container using a high voltage leak detection process; and
a controller configured to perform a method according to claim 1.

12. The system of claim 11, further comprising at least one additional testing device.

13. The system of claim 12, wherein the at least one additional testing device comprises one or more of:
a static image testing device; and
a spin image testing device.

14. The system of claim 13, wherein the static image testing device is arranged before the high voltage leak detection tester and the spin image testing device is arranged after the high voltage leak detection tester.

15. A non-transitory computer readable medium having stored thereon instructions which when executed by a processor perform a method comprising:
receiving a container in a vertical orientation, the container made from a non-conductive material and at least partially filed with a conductive liquid;
spinning the container in the vertical orientation up to a first RPM level, thereby causing the conductive liquid to rise up sides of the container; and
testing for a leak in the spinning container while in the vertical orientation using a high-voltage leak detection process.

16. The non-transitory computer readable medium of claim 15, wherein the method performed when executing the instructions further comprising:
after spinning the container up to the first RPM level and before testing for the leak, reducing the RPM to a second RPM level lower than the first RPM level.

17. The non-transitory computer readable medium of claim 16, wherein the first RPM level is above a testing RPM range of the high-voltage leak detection process and the second RPM level is within the testing RPM range of the high-voltage leak detection process.

18. The non-transitory computer readable medium of claim 16, wherein the first RPM level is approximately 3000 RPMs and the second RPM level is approximately 1500 RPMs.

19. The non-transitory computer readable medium of claim 15, wherein the first RPM level is within a testing RPM range of the high-voltage leak detection process.
